(19) United States
(12) Patent Application Publication
(10) Pub. No.: US 2007/0014254 A1
(43) Pub. Date: Jan. 18, 2007

(54) Method and apparatus for measuring uplink data throughput in WiBro repeater

(76) Inventors: Sung-hyun Chung, Seongnam-si (KR); Min-joong Rim, Seoul (KR); Mi-seon Jeong, Gumi-si (KR)

Correspondence Address: CANTOR COLBURN, LLP, 55 GRIFFIN ROAD SOUTH, BLOOMFIELD, CT, 06002, US

(21) Appl. No.: 11/432,786

(22) Filed: May 11, 2006

Related U.S. Application Data
(60) Provisional application No. 60/699,835, filed on Jul. 15, 2005.

(30) Foreign Application Priority Data
Oct. 25, 2005 (KR) 10-2005-100935

(51) Int. Cl. H04B 7/185

(52) U.S. Cl. 370/318

(57) ABSTRACT

Disclosed is a method of measuring the throughput of uplink data in a WiBro repeater, the method including the operations of: (a) extracting a plurality of tiles from a predetermined number of symbols that are collected over a plurality of times by performing frequency conversion on the uplink data; (b) calculating power values for the respective extracted tiles; (c) calculating an average noise value from the calculated power values; (d) calculating a threshold value, which is used to identify noise, from the average noise value, and calculating the number of tiles having power values more than the threshold value; and (e) calculating the throughput by estimating based on the number of the tiles the number of subchannels carrying data.

This application claims the priority of U.S. Provisional Patent Application No. 60/699,835, filed on Jul. 15, 2005, in the United States Patent and Trademark Office, and the priority of Korean Patent Application No. 2005-100935, filed on Oct. 25, 2005, in the Korean Intellectual Property Office, the disclosures of which are incorporated herein in their entireties by reference.

### BACKGROUND OF THE INVENTION

1. Field of the Invention

The present invention relates to a WiBro system and, more particularly, to a method and apparatus for measuring uplink data throughput in a WiBro repeater.

2. Description of Related Art

A wireless broadband (WiBro) system provides high-data-rate wireless Internet access under the stationary or mobile environment, anytime and anywhere. A currently available mobile phone provides a wide coverage area and high mobility, but does not provide IP-based high-speed data service efficiently. On the contrary, high-speed Internet and wireless LAN supports the IP-based high-speed data service, but provides a narrow coverage area and low mobility. On the other hand, the WiBro system that provides IP-based content is more economical compared to the mobile phone. Further, the WiBro system can provide a wider coverage area compared to the high-speed Internet or wireless LAN, and is suitable for a mobile communication environment.

In the WiBro system, repeaters are used to eliminate indoor dead spots and to improve service quality in areas where portable Internet services are provided. The repeaters are installed in buildings or in poor service areas between portable subscriber stations (PSS) and radio access stations (RAS) to repeat radio wave so that the service quality can be improved and the dead spots can be eliminated.

On the other hand, when the WiBro network is constructed, the position of RAS is determined based on traffics. In the early stage of the network construction, more repeaters are installed than RASs since the repeaters are less expensive than the RASs. However, as the traffic increases, the repeaters are gradually substituted by the RASs. Thus, it is necessary to measure and estimate the traffic amount of each repeater. In other words, if the amount of data transmitted through a repeater exceeds a predetermined threshold, an additional RAS needs to be installed instead of the repeater so that the network can be reliably operated.

When the throughput of a repeater is too low, it may be estimated that there is a problem in cell planning. When the throughput decreases unexpectedly, the repeater may be estimated to be malfunctioning. On the contrary, when the throughput increases unexpectedly, an additional repeater needs to be installed. However, it is difficult to accurately estimate the traffic, and the approximate amount of traffic and the peak rate of data may be measured on a time basis to avoid the above-mentioned problems. Since data transmitted from the RAS is broadcast, it is difficult to measure the traffic of the repeater even though downlink data is monitored.

Thus, the traffic of the repeater is generally measured by monitoring the uplink data. The uplink throughput can be generally measured with a dynamic parameter or a static parameter.

A method of measuring the uplink throughput with the dynamic parameter refers to an Uplink-MAP (UL-MAP) to determine the accurate position of uplink data, receives uplink channel descriptor (UCD) from a RAS, and determines the format of the uplink data. In this case, it is possible to determine whether or not there is actual data by collecting data on subchannels in which the uplink data may be present and then performing turbo decoding on the collected data. Messages on the downlink and uplink need to be interpreted to make an accurate measurement of the data. Accordingly, in order to perform the above-mentioned process in real time, the repeater needs to include part of modem receive functions of the PSS and the RAS, i.e., functions of referring to UL-MAP, receiving UCD, and performing turbo decoding, which requires a great deal of time and cost.

In a method of measuring the uplink throughput with the static parameter, the repeater receives minimum information that does not change frequently through a network management system (NMS) and measures an approximate amount of data. Since the method does not need to include the function of receiving UCD, it is possible to reduce the time and cost compared to the method using the dynamic parameter. However, it is not possible to measure the accurate amount of data.

### SUMMARY OF THE INVENTION

The present invention provides a method and apparatus for measuring uplink data throughput by using a static parameter and determining whether or not signals are present on each channel by detecting energy in uplink data.

According to an aspect of the present invention, there is provided a method of measuring the throughput of uplink data in a WiBro repeater, the method including the operations of: (a) extracting a plurality of tiles from a predetermined number of symbols that are collected over a plurality of times by performing frequency conversion on the uplink data; (b) calculating power values for the respective extracted tiles; (c) calculating an average noise value from the calculated power values; (d) calculating a threshold value, which is used to identify noise, from the average noise value, and calculating the number of tiles having power values more than the threshold value; and (e) calculating the throughput by estimating based on the number of the tiles the number of subchannels carrying data.

The operation (a) may involve extracting a plurality of tiles from a predetermined number of symbols that are collected over a plurality of times by performing FFT (Fast Fourier Transform) on the uplink data and then removing a guard tone from the FFT result.

The operation (a) may include: (a1) performing FFT on the uplink data to obtain 1,024 subcarriers; and (a2) removing a guard tone from the FFT result to obtain 840 symbols, and extracting tiles after receiving the 840 symbols three times.

The operation (c) may involve arranging the calculated power values in order from smallest to largest, selecting and averaging a predetermined number of smallest values to calculate an average noise value.

The operation (d) may include: (d1) calculating a threshold value from the average noise value on which a setup value used to identify noise is reflected; and (d2) calculating the number of tiles having power values more than the threshold value among the tiles.

The operation (e) may involve calculating the number of subchannels by dividing the calculated number of tiles by the number of tiles included in a single subchannel and adding to a quotient resulting from the division a value obtained by rounding up a remainder resulting from the division on the basis of the number of tiles included in the single subchannel, and calculating the throughput by comparing the calculated number of subchannels with a total number of channels.

The tile may be a PUSC tile, an OPUSC tile, or an AMC bin.

According to another aspect of the present invention, there is provided an apparatus for measuring the throughput of uplink data in a WiBro repeater, the apparatus including: a tile extracting unit that extracts a plurality of tiles from a predetermined number of symbols that are collected over a plurality of times by performing frequency conversion on the uplink data; a tile power calculator that calculates power values for the respective extracted tiles; an average noise value calculator that calculates an average noise value from the calculated power values; a threshold value calculator that calculates a threshold value from the average noise value on which a setup value used to identify noise is reflected; a comparator that calculates the number of tiles having power values more than the threshold value among the tiles; and a throughput calculator that calculates the throughput by estimating based on the number of the tiles the number of subchannels carrying data.

The tile extracting unit may extract a plurality of tiles from a predetermined number of symbols that are collected over a plurality of times by performing FFT on the uplink data and then removing a guard tone from the FFT result.

The tile extracting unit may include: a FFT processing unit that performs FFT on the uplink data to obtain 1,024 subcarriers; and a tile extracting unit that removes a guard tone from the FFT result to obtain 840 symbols, and extracts tiles after receiving the 840 symbols three times.

The average noise value calculator may arrange the calculated power values in order from smallest to largest, select and average a predetermined number of smallest values to calculate an average noise value.

The throughput calculator may calculate the number of subchannels by dividing the calculated number of tiles by the number of tiles included in a single subchannel and adding to a quotient resulting from the division a value obtained by rounding up a remainder resulting from the division on the basis of the number of tiles included in the single subchannel, and calculate the throughput by comparing the calculated number of subchannels with a total number of channels.

According to another aspect of the present invention, there is provided a computer readable recording medium that records a program for implementing on a computer the method according to the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of explaining a method of transmitting data in a WiBro system by the use of TDD scheme;

FIG. 2A to 2C are structures of data transmitted through an uplink;

FIG. 3 is a structure of each subchannel on an uplink in a WiBro system that uses a PUSC tile structure;

FIG. 4 is a block diagram of an apparatus for measuring uplink throughput according to an embodiment of the present invention;

FIG. 5 is a flow chart of a method of measuring uplink throughput in a WiBro system that uses a PUSC tile structure according to an embodiment of the present invention;

FIG. 6 is a tester for measuring throughput by a throughput measurement method according to the present invention; and

FIG. 7A is a graph of throughput versus SNR results, and FIG. 7B shows detected energy from each tile in a single slot by the use of the tester shown in FIG. 6.

### DETAILED DESCRIPTION OF THE INVENTION

Exemplary embodiments in accordance with the present invention will now be described in detail with reference to the accompanying drawings.

While a CDMA system with code division duplex (CDD) mode performs power control according to a channel condition, a WiBro system with time division duplex (TDD) mode supplies constant power instead of performing power control and adjusts the amount of data according to channel condition. The amount of data is adjusted through Adaptive Modulation and Coding (AMC) and Hybrid Automatic Repeat Request (HARQ). While the great amount of data can be transmitted in a high signal-to-noise ratio (SNR) environment, the small amount of data is transmitted in a low SNR environment. Thus, the amount of data can be determined by SNR in the WiBro system. In the WiBro system, the amount of data per subchannel is also determined by SNR. Accordingly, the amount of data is proportional to both the number of subchannels and the SNR.

In order to measure the throughput of a repeater, wireless resource occupancy rate or the amount of data is measured. The term “wireless resource occupancy rate” implies the number of subchannels that are being occupied among uplink subchannels. However, it does not represent the accurate amount of data since the number of subchannels varies according to a modulation method and a channel encoding method.

In order to measure the amount of data, the amount of data per subchannel needs to be principally determined through a modulation method and a channel encoding method. However, the approximate amount of data may be estimated by SNR. It is difficult to determine whether the great amount of data implies that there are a great many users with good SNR, or that many wireless resources are occupied. In addition, the amount of data needs to be measured to monitor whether or not SNR decreases and traffic is therefore reduced due to malfunction of the repeater or a change in environment. When the repeater is not properly operating or interference increases, SNR decreases. In this case, more wireless resources may be occupied.

In the present invention, the number of occupied subchannels per unit time is measured to measure the uplink throughput. In this case, the wireless resource occupancy rate is basically measured. However, when SNR is low, it is difficult to search the occupied subchannels. Thus, the present invention considers SNR in addition to measuring the wireless resource occupancy rate. Thus, when SNR is low, a result similar to measuring the amount of data can be obtained. As a result, it is notified to a system operator that a new RAS needs to be installed when the number of occupied subchannels per unit time reaches a threshold value, and that there may be a problem in a repeater environment when the number of occupied subchannels per unit time approaches to zero.

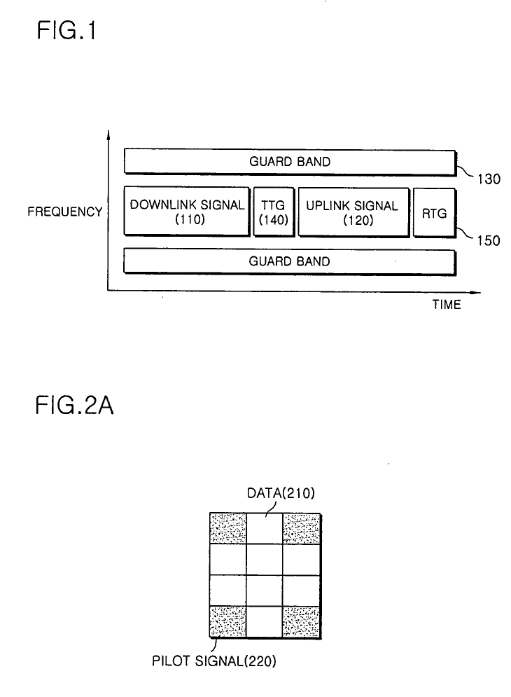

FIG. 1 is a diagram of explaining a method of transmitting data in a WiBro system by the use of TDD scheme.

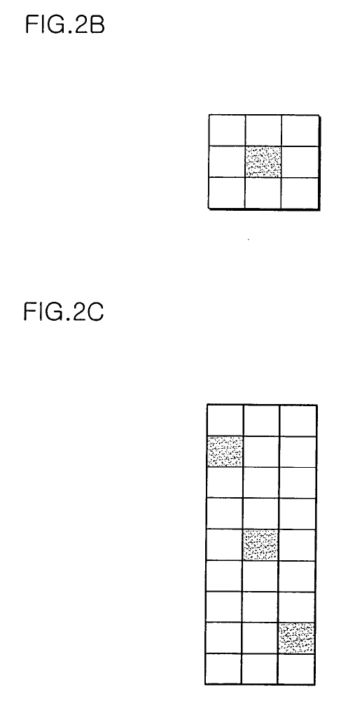

It can be seen from FIG. 1 that in the WiBro system, data is transmitted in TDD mode and separated into a downlink (DL) signal 110 and an uplink (UL) signal 120 on a time axis. When a RAS is switched from a transmit mode to a receive mode and a PSS is switched from a receive mode to a transmit mode, a transmit/receive transition gap (TTG) 140 is set to be placed between the DL signal and the following UL signal. When the RAS is switched from the receive mode to the transmit mode and the PSS is switched from the transmit mode to the receive mode, a receive/transmit transition gap (RTG) 150 is set to be placed between the UL signal and the following DL signal. In addition, a guard band (GB) 130 is set to prevent the DL signal 110 and the UL signal 120 from being interfered with other frequency band. The UP signal 120 is transmitted based on a tile structure, which will be described with reference to FIGS. 2A to 2C.

FIGS. 2A to 2C are structures of data transmitted through an uplink.

In FIG. 2A, a PUSC (partial usage of subchannels) tile consists of 4×3 subcarrier data which includes data 210 or pilot signals 220. The position of the pilot signal may change. In FIG. 2B, the pilot signal is located at a central portion of an OPUSC (optional partial usage of subchannels) tile. In case of AMC bin (adaptive modulation & coding bin), as shown in FIG. 2C, a single bin is obtained after nine subcarriers are received three times.

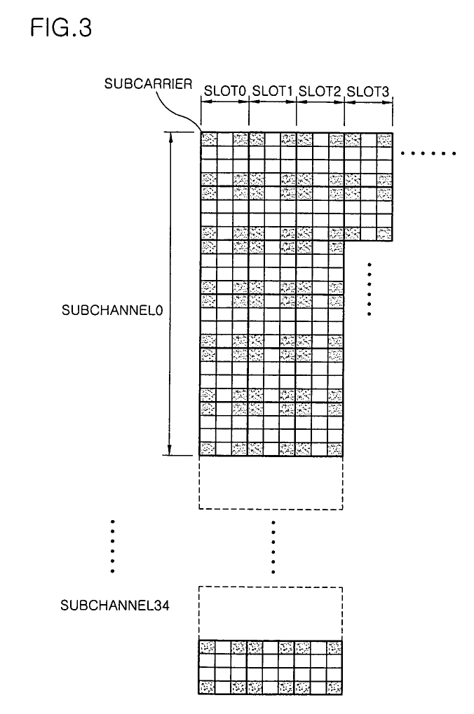

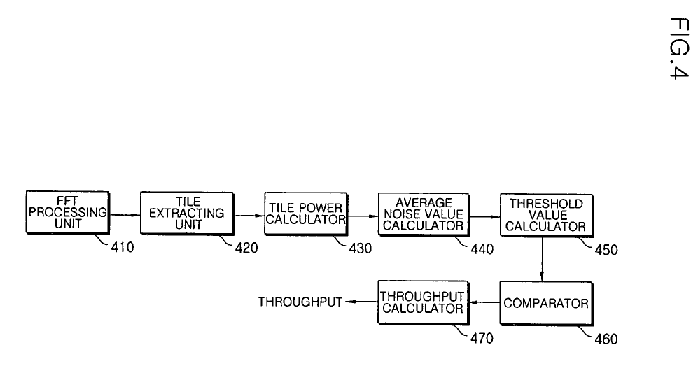

FIG. 3 is a structure of each subchannel on an uplink in a WiBro system that uses a PUSC tile structure.

When data received through an uplink channel is subjected to FFT processing, an OFDMA (orthogonal frequency division multiple access) symbol consisting of 1,024 subcarriers is obtained. After a guard tone inserted to prevent the symbol from being interfered with neighboring frequency band is removed from the symbol, 840 subcarriers are obtained. Thirty five subchannels are obtained from the 840 subcarriers by setting twenty four subcarriers into a subchannel. As shown in FIG. 2A, since the PUSC tile consists of 4×3 subcarriers, three symbols need to be received to make a single PUSC tile. Thus, a single subchannel includes six PUSC tiles. If there is the remaining time allotted to the uplink, the OFMDA symbols are received again and the PUSC tile is produced according to the above-mentioned process. That is, when there is the remaining time allotted to the uplink, tiles can be continuously received. The time taken for a single tile to be received is referred to as a slot.

FIG. 4 is a block diagram of an apparatus for measuring uplink throughput according to an embodiment of the present invention.

The apparatus for measuring uplink throughput includes a FFT processing unit 410, a tile extracting unit 420, a tile power calculator 430, an average noise value calculator 440, a threshold value calculator 450, a comparator 460, and a throughput calculator 470.

The FFT processing unit 410 performs FFT processing, for example, for the uplink data shown in FIG. 3 to obtain 1,024 subcarriers. The OPUSC tile or the AMC bin as shown in FIGS. 2B or 2C may be employed instead of the PUSC tile shown in FIG. 2A. The tile extracting unit 420 removes the guard tone from the resultant FFT value to obtain 840 symbols, and extracts a tile after receiving three symbols. As described above, the guard tone, which is inserted to prevent the OFDMA symbol from being interfered with other symbol, is removed from the OFDMA symbol, and a single PUSC tile consists of 4×3 subcarrier.

The tile power calculator 430 calculates a power value for each tile thus extracted. That is, when three symbols are received and 210 tiles are obtained, a power value for each of the tiles is calculated. The power value is calculated by squaring real part and imaginary part of each of the received subcarriers, which is represented in form of a complex signal, and then adding the number of subcarriers within the tile. The average noise value calculator 440 arranges the calculated power values for the 210 tiles in order from smallest to largest, and selects some of the smallest values to calculate an average noise value. The number of the smallest values to be selected is predetermined and may be varied by a user. For example, sixteen of the smallest values are selected and averaged to obtain an average noise value.

The threshold value calculator 450 calculates a threshold value from the average noise value on which a predetermined setup value is reflected. The setup value is used to determine whether or not a signal is regarded as noise. For example, signals having values less than the predetermined setup value are regarded as noise, and the threshold value is accordingly calculated. The predetermined value may be varied by a user. The comparator 460 compares the calculated threshold value with the power value for each of the 210 tiles, and counts and outputs the number of tiles having power values more than the threshold value.

Based on the counted number of tiles, the throughput calculator 470 estimates the number of subchannels that are currently having data and calculates the throughput. The throughput calculator 470 calculates the number of subchannels by dividing the calculated number of tiles by the number of tiles constituting a single subchannel, i.e., 6 (six), and adding to a quotient resulting from the division a value obtained by rounding up a remainder resulting from the division on the basis of the numeral 6, and calculates the throughput by comparing the calculated number of subchannels with a total number of channels. That is, since a single subchannel has six tiles, data is not determined to be present in a corresponding subchannel when 0, 1, or 2 tiles are detected, and data is determined to be present in a corresponding subchannel when more than 3 tiles are detected. Throughput measurement results will now be described in detail.

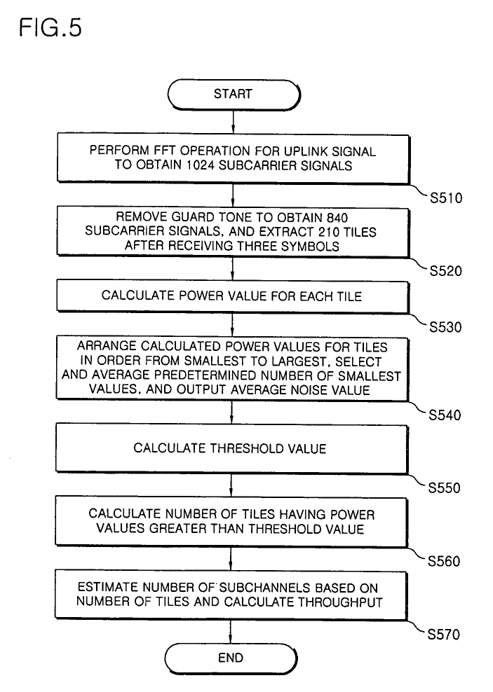

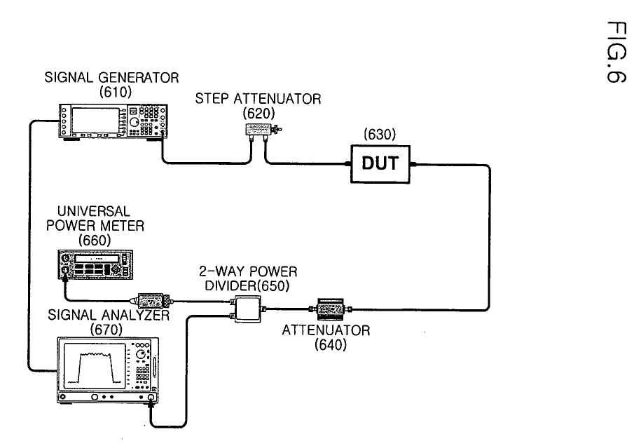

FIG. 5 is a flow chart of a method of measuring uplink throughput in a WiBro system that uses a PUSC tile structure according to an embodiment of the present invention.

First, FFT processing is performed for the above-mentioned uplink data (operation S510). The OPUSC tile or the AMC bin as shown in FIG. 2B or 2C may be employed instead of the PUSC tile shown in FIG. 2A. Next, 840 symbols are obtained by removing a guard tone from the resultant FFT value, and a tile is extracted after three symbols are received (S520). That is, as described above, the guard tone inserted to prevent the OFDMA symbol from being interfered with other symbols is removed. Next, since a single PUSC tile consists of 4×3 subcarriers, the tile is extracted after three OFDMA symbols consisting of 840 subcarriers are received.

A power value for each of the extracted tiles is calculated (S530). That is, when three OFDMA symbols are received and 210 tiles are obtained, a power value for each tile is calculated. The power values for the 210 tiles thus calculated are arranged in order from smallest to largest, and some of the smallest values are selected to obtain an average noise value (S540) The number of the smallest values to be selected is predetermined, and may be varied by a user. For example, sixteen of the smallest values are selected and averaged to obtain the average noise value.

Next, a threshold value is calculated from the average noise value on which a predetermined setup value is reflected (S550). The setup value is used to determine whether or not a signal is regarded as noise. For example, signals having values less than the predetermined setup value are regarded as noise, and the threshold value is accordingly calculated. The setup value may be varied by a user. The calculated threshold value is compared with the power value for each of 210 tiles, and the number of tiles having power values more than the threshold value is counted and output (S560).

Based on the counted number of tiles, the number of subchannels that are currently having data is estimated to calculate the throughput (S570). That is, the number of subchannels is calculated by dividing the calculated number of tiles by the number of tiles constituting a single subchannel, i.e., 6 (six), and adding to a quotient resulting from the division a value obtained by rounding up a remainder resulting from the division on the basis of the numeral 6, and the throughput is calculated by comparing the calculated number of subchannels with a total number of channels. That is, since a single subchannel has six tiles, data is not determined to be present in a corresponding subchannel when 0, 1, or 2 tiles are detected, and data is determined to be present in a corresponding subchannel when more than 3 tiles are detected.

FIG. 6 is a tester for measuring the throughput by a throughput measurement method according to the present invention.

The tester includes a signal generator 610, a step attenuator 620, a device under test (DUT) 630, an attenuator 640, a 2-way power divider 650, a universal power meter 660, and a signal analyzer 670.

A test for measuring the throughput is performed in such a channel environment that AWGN (additive white Gaussian noise) is included in a channel, an operating frequency is 2.345 GHz, a RF level is −70 dBm, and a reference throughput to be measured is 10%. A signal generated in the signal generator 610 has a frame length of 5 ms, is a 4× oversampled windowed signal, and has a PUSC tile structure on an uplink. The test has been performed for an ideal channel and a fading channel. That is, it has been tested whether a throughput of 10% is detected while varying the RF input level when a signal generated by the signal generator 610 is applied to the DUT 630.

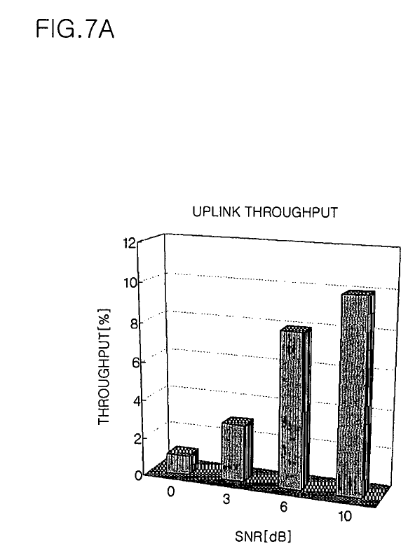

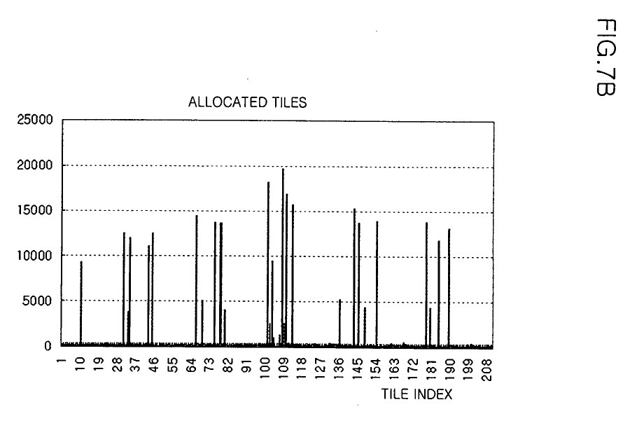

FIG. 7A is a graph of throughput versus SNR results.

It can be seen from FIG. 7A that an accurate wireless resource occupancy rate is obtained when SNR is high, and a slightly low wireless resource occupancy rate is obtained when SNR is low. Thus, it is possible to estimate an approximate throughput.

FIG. 7B shows detected energy from each tile in a single slot by the use of the tester shown in FIG. 6.

It can be seen from FIG. 7B that tiles are allocated all over the frequency bands and signals are present in about 10% of the 210 tiles.

On the other hand, the above-mentioned throughput measurement method can be written with a computer program. Codes and code segments constituting the program can be easily inferred by computer programmers in the art. The program is stored in a computer readable medium, read and executed by a computer to implement the throughput measurement method. Examples of the computer readable medium include a magnetic recording medium, an optical recording medium, and a carrier wave medium.

As apparent from the above description, it is possible to easily measure the uplink data throughput by measuring the power value of an uplink signal and estimating whether or not data is present in each subchannel.

While the present invention has been described with reference to exemplary embodiments thereof, it will be understood by those skilled in the art that various changes in form and details may be made therein without departing from the scope of the present invention as defined by the following claims.

What is claimed is:

1. A method of measuring the throughput of uplink data in a WiBro repeater, the method comprising the operations of:
(a) extracting a plurality of tiles from a predetermined number of symbols that are collected over a plurality of times by performing frequency conversion on the uplink data;
(b) calculating power values for the respective extracted tiles;
(c) calculating an average noise value from the calculated power values;
(d) calculating a threshold value, which is used to identify noise, from the average noise value, and calculating the number of tiles having power values more than the threshold value; and
(e) calculating the throughput by estimating based on the number of the tiles the number of subchannels carrying data.

2. The method of claim 1, wherein the operation (a) involves extracting a plurality of tiles from a predetermined number of symbols that are collected over a plurality of times by performing FFT (Fast Fourier Transform) on the uplink data and then removing a guard tone from the FFT result.

3. The method of claim 2, wherein the operation (a) includes:
(a1) performing FFT on the uplink data to obtain 1,024 subcarriers; and
(a2) removing a guard tone from the FFT result to obtain 840 symbols, and extracting tiles after receiving the 840 symbols three times.

4. The method of claim 1, wherein the operation (c) involves arranging the calculated power values in order from smallest to largest, selecting and averaging a predetermined number of smallest values to calculate an average noise value.

5. The method of claim 1, wherein the operation (d) includes:
(d1) calculating a threshold value from the average noise value on which a setup value used to identify noise is reflected; and
(d2) calculating the number of tiles having power values more than the threshold value among the tiles.

6. The method of claim 1, wherein the operation (e) involves calculating the number of subchannels by dividing the calculated number of tiles by the number of tiles included in a single subchannel and adding to a quotient resulting from the division a value obtained by rounding up a remainder resulting from the division on the basis of the number of tiles included in the single subchannel, and calculating the throughput by comparing the calculated number of subchannels with a total number of channels.

7. The method of claim 1, wherein the tile is a PUSC tile, an OPUSC tile, or an AMC bin.

8. An apparatus for measuring the throughput of uplink data in a WiBro repeater, the apparatus comprising:
a tile extracting unit that extracts a plurality of tiles from a predetermined number of symbols that are collected over a plurality of times by performing frequency conversion on the uplink data;
a tile power calculator that calculates power values for the respective extracted tiles;
an average noise value calculator that calculates an average noise value from the calculated power values;
a threshold value calculator that calculates a threshold value from the average noise value on which a setup value used to identify noise is reflected;
a comparator that calculates the number of tiles having power values more than the threshold value among the tiles; and
a throughput calculator that calculates the throughput by estimating based on the number of the tiles the number of subchannels carrying data.

9. The apparatus of claim 8, wherein the tile extracting unit extracts a plurality of tiles from a predetermined number of symbols that are collected over a plurality of times by performing FFT on the uplink data and then removing a guard tone from the FFT result.

10. The apparatus of claim 9, wherein the tile extracting unit includes:
a FFT processing unit that performs FFT on the uplink data to obtain 1,024 subcarriers; and
a tile extracting unit that removes a guard tone from the FFT result to obtain 840 symbols, and extracts tiles after receiving the 840 symbols three times.

11. The apparatus of claim 8, wherein the average noise value calculator arranges the calculated power values in order from smallest to largest, selects and averages a predetermined number of smallest values to calculate an average noise value.

12. The apparatus of claim 8, wherein the throughput calculator calculates the number of subchannels by dividing the calculated number of tiles by the number of tiles included in a single subchannel and adding to a quotient resulting from the division a value obtained by rounding up a remainder resulting from the division on the basis of the number of tiles included in the single subchannel, and calculates the throughput by comparing the calculated number of subchannels with a total number of channels.

13. A computer readable recording medium that records a program for implementing on a computer the method of claim 1.
